(19) United States
(12) Patent Application Publication
(10) Pub. No.: US 2019/0227646 A1
(43) Pub. Date: Jul. 25, 2019

(54) TOUCH PANEL

(71) Applicant: Wuhan China Star Optoelectronics Semiconductor Display Technology Co., Ltd., Wuhan (CN)

(72) Inventor: Jian YE, Shenzhen (CN)

(21) Appl. No.: 16/023,676

(22) Filed: Jun. 29, 2018

Related U.S. Application Data
(63) Continuation of application No. PCT/CN2018/074990, filed on Feb. 1, 2018.

(30) Foreign Application Priority Data
Jan. 25, 2018 (CN) 201810075185.0

(51) Int. Cl. G06F 3/041

(52) U.S. Cl. CPC G06F 3/041; G06F 2203/04102

(57) ABSTRACT

The present invention provides a touch panel where every two adjacent first electrodes are electrically connected by a first connection element. Each first connection element includes at least one conductive bridge. These conductive bridges jointly sustain the bending stress when the touch panel is bent, effectively reducing the bending stress distributed on each conductive bridge and thereby preventing the touch panel from breaking. Multiple vias are formed on each conductive bridge, further reducing the bending stress on each conductive bridge and preventing the touch panel from breaking.

### CROSS-REFERENCE TO RELATED APPLICATIONS

This application is a continuing application of PCT Patent Application No. PCT/CN2018/074990, filed on Feb. 1, 2018, which claims priority to Chinese Patent Application No. 201810075185.0, filed on Jan. 25, 2018, both of which are hereby incorporated herein by reference in their entireties.

### FIELD OF THE INVENTION

The present invention is generally related to touch panels, and more particular to a touch panel of better bending capability.

### BACKGROUND OF THE INVENTION

Flexible Organic Light Emitting Diode (OLED), due to its low power consumption and bendable feature, has received wide attention. To achieve the bending of an OLED display, not only that the OLED panel should have enhanced bending capability, but also that the touch panel attached to the OLED panel should have similarly enhanced bending capability. Otherwise, the touch panel would break when the OLED display is bent.

### SUMMARY OF THE INVENTION

The present invention provides a touch panel of better bending capability.

The touch panel includes a touch layer. The touch layer includes:

multiple first electrode chains arranged at intervals, each including multiple first electrodes at intervals, where every two adjacent first electrodes are electrically connected by a first connection element, each first connection element includes at least one conductive bridge, and the at least one conductive bridge has multiple vias at intervals; and

multiple second electrode chains arranged at intervals crossing but insulated from the first electrode chains, each including multiple second electrodes at intervals, where every two adjacent second electrodes are electrically connected by a second connection element, and the first connection elements are disposed on and insulated from the second connection elements.

In one embodiment, the at least one conductive bridge has two separated and linear long edges.

In one embodiment, the at least one conductive bridge has two separated and curved long edges. Each long edge includes multiple crests at intervals. There is a trough between every two adjacent crests. The crests along the two long edges are positioned oppositely to each other. Each via is positioned between a pair of corresponding crests.

In one embodiment, each first connection element includes multiple conductive bridges arranged in parallel or crossing each other.

In one embodiment, each first connection element further includes at least one connecting strip connecting the conductive bridges.

In one embodiment, the at least one connecting strip has multiple vias at intervals. In one embodiment, a first connecting strip runs across the conductive bridges and connects a first end of each conductive bridge. A second connecting strip runs across the conductive bridges and connects a second end of each conductive bridge opposite to the first end. The first and second connecting strips are disposed on the adjacent first electrodes connected by the first connection element, respectively.

In one embodiment, the at least one connecting strip runs across the conductive bridges and connects the conductive bridges at their middles.

In one embodiment, the touch panel further includes a lid disposed on the touch layer. The touch layer is attached to an inner side of the lid.

In one embodiment, the lid is a 3D lid. The lid includes a first plane and two curved planes to the lateral sides of and connected to the first plane. Each curved plane curves from the first plane towards a direction perpendicular to the first plane. The first connection elements are extended along a direction identical to an extension direction of the curved planes' curvature axes.

For the described touch panel, every two adjacent first electrodes are electrically connected by a first connection element. Each first connection element includes at least one conductive bridge. These conductive bridges jointly sustain the bending stress when the touch panel is bent, effectively reducing the bending stress distributed on each conductive bridge and thereby preventing the touch panel from breaking. Multiple vias are formed on each conductive bridge, further reducing the bending stress on each conductive bridge and preventing the touch panel from breaking.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

To make the technical solution of the embodiments according to the present disclosure, a brief description of the drawings that are necessary for the illustration of the embodiments will be given as follows. Apparently the drawings described below show only example embodiments of the present disclosure and for those having ordinary skills in the art, other drawings may be easily obtained from these drawings without paying any creative effort. In the drawings:

FIG. 1 is a schematic diagram showing a touch panel according to a first embodiment of the present invention:

FIG. 2 is a schematic enlarged diagram showing a part of the touch panel in a circle II of FIG. 1:

FIG. 3 is a schematic sectional diagram showing the touch panel of FIG. 2 along the I-I line:

FIG. 4 is a schematic sectional diagram showing a touch panel according to a second embodiment of the present invention along the I-I line;

FIG. 5 is a schematic diagram showing a first connection element according to a first embodiment of the present invention;

FIG. 6 is a schematic diagram showing a first connection element according to a third embodiment of the present invention:

FIG. 7 is a schematic diagram showing a first connection element connecting two adjacent first electrodes according to another embodiment of the present invention:

FIG. 8 is a schematic diagram showing a first connection element connecting two adjacent first electrodes according to yet another embodiment of the present invention:

FIG. 9 is a schematic diagram showing a first connection element connecting two adjacent first electrodes according to still another embodiment of the present invention;

FIG. 10 is a schematic diagram showing a first connection element according to a fourth embodiment of the present invention:

FIG. 11 is a schematic diagram showing a first connection element according to a fifth embodiment of the present invention; and

FIG. 12 is a schematic diagram showing a first connection element according to a sixth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

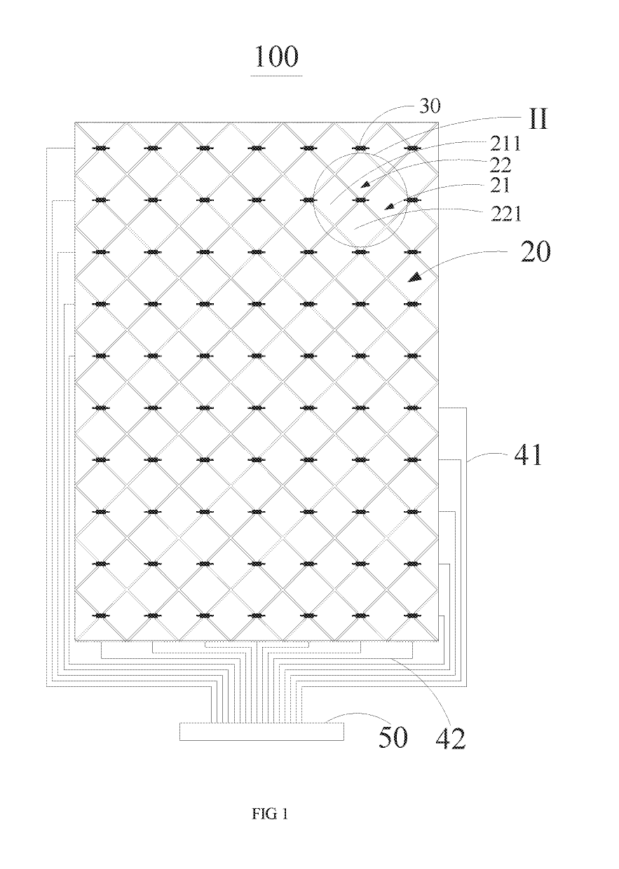

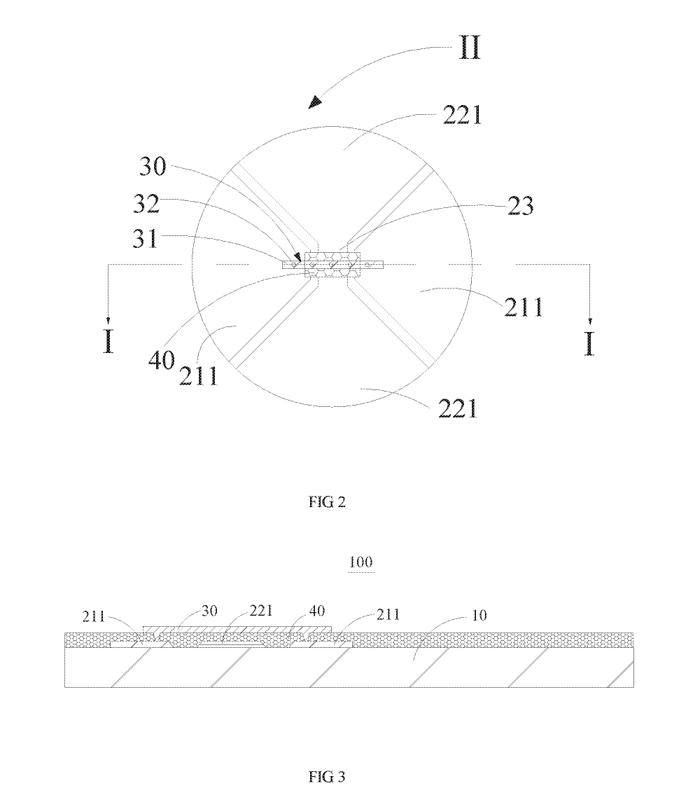

As shown in FIGS. 1 and 2, a touch panel 100 according to a first embodiment of the present invention includes a substrate 10 and a touch layer 20 on the substrate 10. The touch layer 20 provides the touch-sensitive function for the touch panel 100.

The touch layer 20 includes multiple first electrode chains 21 arranged at intervals and multiple second electrode chains 22 arranged at intervals crossing but insulated from the first electrode chains 21. In the present embodiment the first electrode chains 21 are arranged in parallel and extended along a lateral direction, and the second electrode chain 22 are arranged in parallel and extended along a vertical direction. The first and second electrode chains 21 and 22 are perpendicular to each other. It should be understandable that the extension directions of the first and second electrode chains 21 and 22 may be varied according to requirement.

Each first electrode chain 21 includes multiple first electrodes 211 arranged at intervals. Two adjacent first electrodes 211 are electrically connected by a first connection element 30. Each second electrode chain 22 includes multiple second electrodes 221 arranged at intervals. The first and second electrodes 211 and 221 are formed at a same layer and in the same manufacturing process. In one embodiment, a metallic layer is formed on the substrate and, by patterning the metallic layer, the first and second electrodes 211 and 221 are formed simultaneously. In the present embodiment, two adjacent second electrodes 221 are electrically connected by a second connection element 23. The second connection elements 23 are at the same layer with the first and second electrodes 211 and 221, and the second connection elements 23 are formed by patterning the metallic layer simultaneously when patterning the metallic layer for the first and second electrodes 211 and 221. The second connection elements 23 and the second electrodes 22 are integrally formed in the same manufacturing process. In the present embodiment, each second connection element 23 has a narrow and has a dimension smaller than that of each second electrode 221. It should be understandable that, in alternative embodiments, the connection between two adjacent second electrodes 221 may be achieved by extending a part of one of the two second electrodes 221 towards the other one, or by partially overlapping the two second electrodes 221.

Both first and second electrodes 211 and 221 may function either as drive electrodes (Tx) or as senses electrodes (Rx). If the first electrodes 211 are drive electrodes (Tx), the second electrodes 221 are sense electrodes (Rx). If the first electrodes 211 are sense electrodes (Rx), the second electrodes 221 are drive electrodes (Tx). According to the present invention, the first and second electrodes 211 and 221 have specific shapes so as to facilitate the determination of the touch location and to achieve the touch-sensitive function. In the present embodiment the first and second electrodes 211 and 221 have identical diamond shapes. As the first and second electrode chains 21 and 22 are arranged, two adjacent first electrodes 211 and two adjacent second electrodes 221 jointly form a greater diamond shape.

It should be understandable that the first and second electrodes 211 and 221 may have other shapes such as squares or rectangles. The first and second electrodes 211 and 221 may also have different shapes. For example, in some embodiments, the second electrodes 221 have an elongated shape whereas the first electrodes 211 have a block shape, and the block-shaped first electrodes 211 are disposed to the lateral sides of the elongated second electrodes 221.

According to the present invention, when any location of the touch layer 20 is touched, a capacitance between adjacent first and second electrodes 211 and 221 at the touch location varies. The touch location is then determined by detecting capacitance variation. Specifically, a capacitance is formed involving a first electrode 211, an adjacent second electrode 221, and a medium in between. When the touch layer 20 is touched, the capacitance at the touch location varies, and the touch location is determined by detecting such capacitance change, thereby achieving the touch-sensitive function.

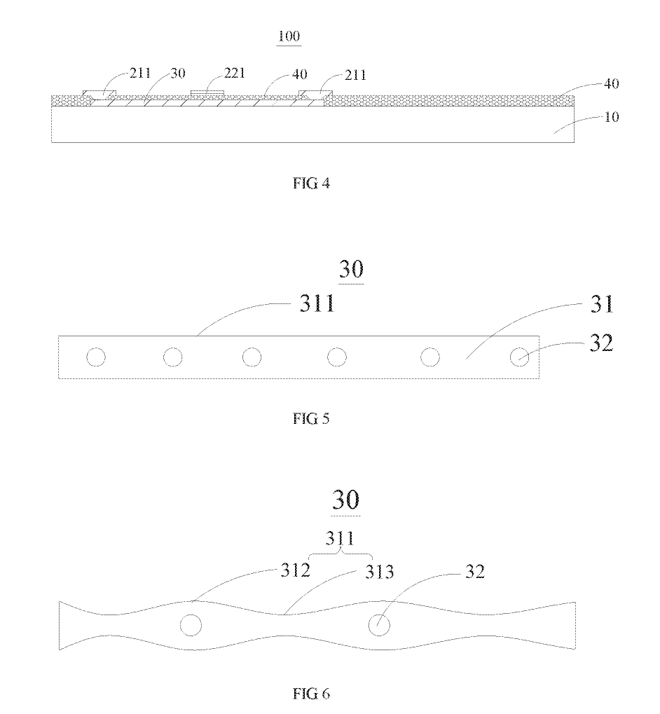

Two adjacent first electrodes 211 are electrically connected by a first connection element 30. The first connection element 30 is disposed on and insulated from the second connection element 23. Specifically, an insulation layer 40 is disposed on the first and second electrodes 211 and 221, and the second connection element 23. A via is formed in the insulation layer 40 corresponding to and exposing a first electrode 211. The first connection element 30 contacts and thereby electrically connects the adjacent first electrodes 211 through the vias. A first connection element 30's two ends connect two adjacent first electrodes 211, thereby electrically connecting the two first electrodes 211. As shown in FIG. 3, the first connection elements 30 and the insulation layer 40 are positioned at a side of the touch layer 20 away from the substrate 10. Vias are formed in the insulation layer 40. The fist connection elements 30 connect adjacent first electrodes 211 through the vias. As shown in FIG. 4, in alternative embodiments, the first connection elements 30 and the insulation layer 40 are positioned on a side of the touch layer 20 facing the substrate 10.

Each first connection element 30 includes at least one elongated conductive bridge 31 whose two ends respectively connect the adjacent two first electrodes 211. As shown in FIG. 5, multiple vias 32 are formed at intervals along the conductive bridge 31. The vias 32 assist in releasing the bending stress exerted on the conductive bridge 31 so as to prevent the first connection element 30 from breaking when the touch panel 100 is bent. Each conductive bridge 31 has two separated and linear long edges 311.

As shown in FIG. 6, in an alternative embodiment, each conductive bridge 31's long edges 311 are curved and include multiple crests 312 at intervals. There is a trough 313 between every two adjacent crests 312. The crests and troughs 312 and 313 may have various shapes, such as semi-circular, hyperbolic, square, triangular, and trapezoidal shapes. The crests 312 along the two long edges 311 are positioned oppositely to each other. Each via 32 is positioned between a pair of corresponding crests 312. The crests 312 along the long edges 311 assist in releasing the bending stress exerted on the conductive bridge 31 so as to prevent the first connection element 30 from breaking when the touch panel 100 is bent. Each conductive bridge 31 has two separated and linear long edges 311. In the present embodiment, the crests 312 and troughs 313 are smoothly connected arcs without any pointed angles so as to prevent the bending stress from concentrating at these pointed angles.

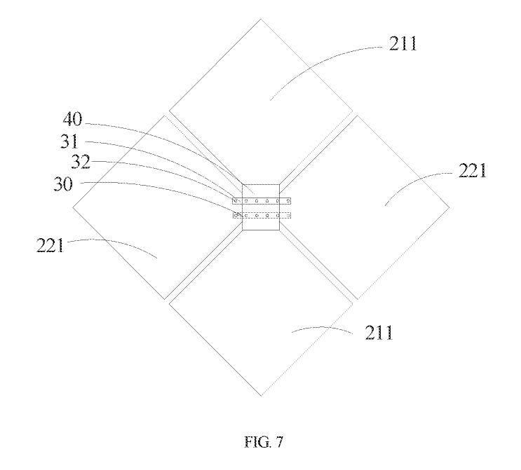

As shown in FIG. 7, in another embodiment of the present invention, each first connection element 30 includes multiple, parallel or crossed, conductive bridges 31. In the present embodiment, the conductive bridges 31 are arranged in parallel separately and independently. In other words, each conductive bridge 31 independently and electrically connects two adjacent first electrodes 211. As such, these conductive bridges 31 jointly sustain the bending stress when the touch panel 100 is bent, effectively reducing the bending stress distributed on each conductive bridge 31 and thereby preventing the conductive bridge 31 from breaking. Furthermore, as there are multiple conductive bridges 31 between adjacent first electrodes 211, each conductive bridge 31 could have a smaller width and a better bending capability further preventing it from breaking. The conductive bridges 31 are also less visible, enhancing the visual appearance of the touch panel 100. Each conductive bridge 31 also has a smaller contact area with the first electrode 211, reducing the contact impedance and improving the sensitivity and reliability of the touch panel 100. In the present embodiment, each conductive bridge 31 may be implemented in accordance with what is described in FIG. 5 or FIG. 6.

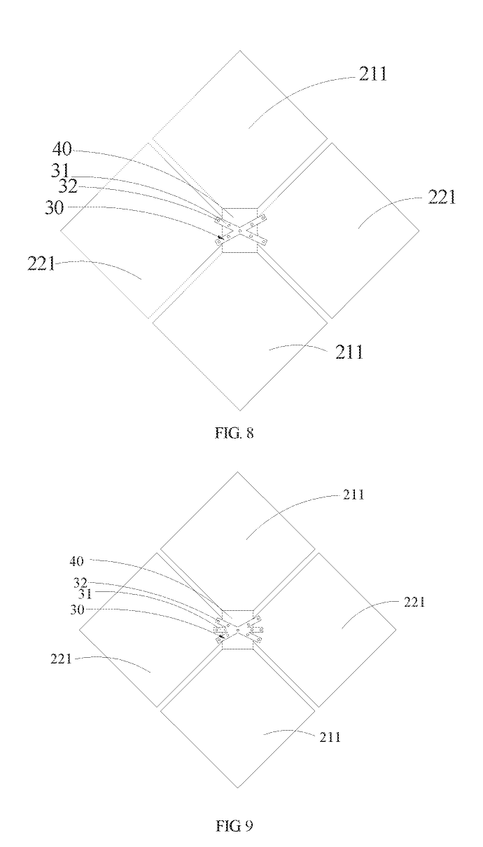

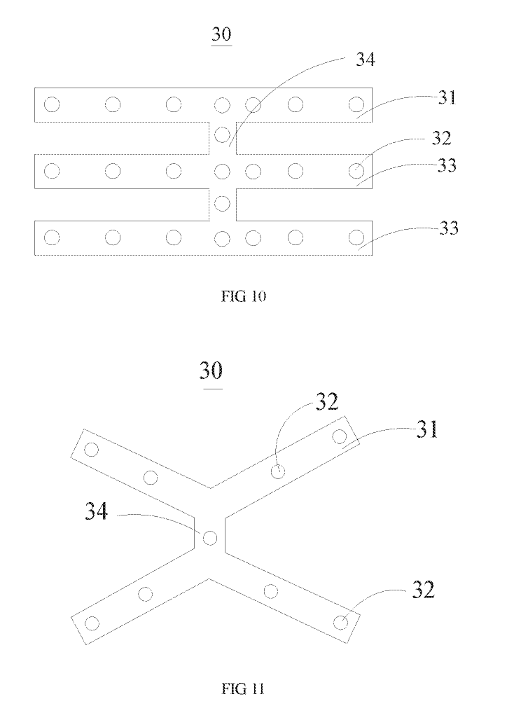

As shown in FIGS. 8 and 9, another embodiment of the touch panel 100 differs from the previous embodiment in that the conductive bridges 31 cross each other at a single point. Specifically, the conductive bridges 31 jointly form an X-like shape. In the present embodiment, each conductive bridge 31 may be implemented in accordance with what is described in FIG. 5 or FIG. 6.

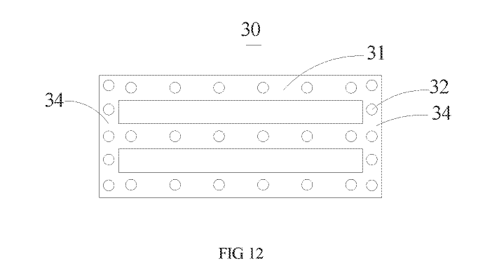

In addition, at least one connecting strip 34 may run across and connect the multiple conductive bridges 31. The one or more connecting strips 34 are formed in a same manufacturing process as the conductive bridges 31. As shown in FIG. 10, the multiple conductive bridges 31 are in parallel and a connecting strip 34 runs perpendicularly across them and connect them at their middles. It should be understandable that, in alternative embodiments, there may be two, three, or more connecting strips 34. The present invention does not require a specific number of connecting strips 34. In the present embodiment, each conductive bridge 31 may be implemented in accordance with what is described in FIG. 5 or FIG. 6. As shown in FIG. 12, in another embodiment, there are two connecting strips 34, one connecting an end of the conductive bridges 31 and the other one connecting the other end of the conductive bridges 31. In this way, the connecting strips 34 enlarge the contact area and thereby enhance the connection between the first connection element 30 and the first electrodes 211. In the meantime, vias 32 are also formed on the connecting strips 34 at intervals, so that the contact impedance between the connecting strips 34 and the connected first electrodes 211 is reduced. Therefore, the touch sensitivity of the touch panel 100 is guaranteed while the reliable connection between the first connection elements 30 and the first electrodes 211 is achieved. According to the present invention, the connecting strips 33 and the multiple conductive bridges 31 are formed in the same manufacturing process, thereby reducing production effort and cost.

As shown in FIG. 11, in another embodiment of the present invention, it differs from what is shown in FIG. 10 in that there is a single connecting strip 34 and two conductive bridges 31, each involving two segments end-to-end joined at an angle. The connecting strip 34 has its two ends connecting the connective bridges 31, respectively, at where their segments meet, thereby forming an X-like shape. It should be understandable that there may be multiple conductive bridges 31, some of them are bent and connected by a connecting strip 34 like what is shown in FIG. 11 into an X-like shape.

Furthermore, the first and second electrode chains 21 and 22 are connected to a control chip 50 through wiring, which includes a set of first wires 41 and a second set of wires 42. In the present embodiment, each first electrode chain 21 is connected to the control chip 50 through a first wire 41, and each second electrode chain 22 is connected to the control chip 50 through a second wire 42. According to the present invention, the multiple first electrodes 211 are connected into a first electrode chain 21 by the first connection elements 30, the multiple second electrodes 221 are connected into a second electrode chain 22 by the second connection elements 23, and each of the first and second electrode chains 21 and 22 requires a single wire to be connected to the control chip 50. Compared to the prior arts where each of the first and second electrodes 211 and 221 requires a wire to connect the control chip 50, the present invention has significantly reduced the number of wires required and the production cost as well. In addition, as the wiring is usually laid out in a touch panel's non-display area, the fewer wires facilitate the reduction of the non-display area of the touch panel, and the fulfillment of full screen display.

Furthermore, the touch panel 100 may also include a lid disposed on the touch layer 20. The touch layer 20 is attached to an inner side of the lid, which protects the touch layer 20 against outside moist and oxygen to prevent them from permeating into the touch layer 20, thereby guaranteeing the touch-sensitive function of the touch layer 20. The lid may be flexible or rigid lid, depending on requirement. In the present embodiment, the lid is a 3D lid suitable for a curved screen display. The lid includes a first plane and two curved planes to the lateral sides of and connected to the first plane. Each curved plane curves from the first plane towards a direction perpendicular to the first plane. The first connection elements 30 are extended along a direction identical to an extension direction of the curved planes' curvature axes. In the present embodiment, the curvature axis of a curved plane is parallel to an edge of the first plane connecting the curved plane. The multiple conductive bridges 31 are parallel, and each conductive bridge 31 is extended in the same direction as the curvature axes of the curved planes. Therefore, as the touch layer 20 is attached to the inner side of the lid and when the touch layer 20 is bent, since the conductive bridges 31 are extended in the same direction as the curvature axes of the curved planes, the risk of breaking the first connection elements 30 is reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

What is claimed is:

1. A touch panel, comprising a touch layer; wherein the touch layer comprises:
a plurality of first electrode chains arranged at intervals, each comprising a plurality of first electrodes at intervals, where every two adjacent first electrodes are electrically connected by a first connection element, each first connection element comprises at least one conductive bridge, and the at least one conductive bridge has a plurality of vias at intervals; and
a plurality of second electrode chains arranged at intervals crossing but insulated from the first electrode chains, each comprising a plurality of second electrodes at intervals, where every two adjacent second electrodes are electrically connected by a second connection element, and the first connection elements are disposed on and insulated from the second connection elements.

2. The touch panel according to claim 1, wherein the at least one conductive bridge has two separated and linear long edges.

3. The touch panel according to claim 1, wherein the at least one conductive bridge has two separated and curved long edges; each long edge of the conductive bridge is curved and comprises a plurality of crests at intervals; a trough is formed between every two adjacent crests; the crests along the two long edges are positioned oppositely to each other; each via is positioned between a pair of corresponding crests.

4. The touch panel according to claim 1, wherein each first connection element comprises a plurality of conductive bridges arranged in parallel or crossing each other.

5. The touch panel according to claim 2, wherein each first connection element comprises a plurality of conductive bridges arranged in parallel or crossing each other.

6. The touch panel according to claim 3, wherein each first connection element comprises a plurality of conductive bridges arranged in parallel or crossing each other.

7. The touch panel according to claim 4, wherein each first connection element further comprises at least one connecting strip connecting the conductive bridges.

8. The touch panel according to claim 7, wherein the at least one connecting strip has a plurality of vias at intervals.

9. The touch panel according to claim 7, wherein a first connecting strip runs across the conductive bridges and connects a first end of each conductive bridge; a second connecting strip runs across the conductive bridges and connects a second end of each conductive bridge opposite to the first end; and the first and second connecting strips are disposed on the adjacent first electrodes connected by the first connection element, respectively.

10. The touch panel according to claim 7, wherein the at least one connecting strip runs across the conductive bridges and connects the conductive bridges at their middles.

11. The touch panel according to claim 1, further comprising a lid disposed on the touch layer; wherein the touch layer is attached to an inner side of the lid.

12. The touch panel according to claim 11, herein the lid is a 3D lid; the lid comprises a first plane and two curved planes to the lateral sides of and connected to the first plane; each curved plane curves from the first plane towards a direction perpendicular to the first plane; and the first connection elements are extended along a direction identical to an extension direction of the curved planes' curvature axes.
